(19) United States
(12) Patent Application Publication
(10) Pub. No.: US 2023/0096285 A1
(43) Pub. Date: Mar. 30, 2023

(54) METHOD AND EQUIPMENT FOR LOGGING, RECORDING AND STORING DATA ON THE TIME OF BIRTH AND LIFE EVENTS OF A USER

(71) Applicant: Nikolai Evgenevich LAYPUKHOV, Georgievsk (RU)

(72) Inventor: Nikolai Evgenevich LAYPUKHOV, Georgievsk (RU)

(21) Appl. No.: 17/301,463

(22) PCT Filed: Dec. 24, 2019
(86) PCT No.: PCT/RU2019/001008

§ 371 Date: Apr. 6, 2021

(30) Foreign Application Priority Data
Dec. 29, 2018 (RU) 2018147527

(51) Int. Cl. G06F 16/22

(52) U.S. Cl. CPC G06F 16/2272

(57) ABSTRACT

The group of inventions concerns a method and equipment for logging, recording data that comprises the time and date of birth of a person, and storing the data throughout the life of a person using a world time and location of birth. The method of logging, recording and storing the user's birth time and life events data includes logging the user's birth time, recording the user's birth time by entering the data into the electronic data logger, linking user birth time to world time and location of user birth, triggering user life time measurement in seconds or minutes or hours or days of planet Earth, taking into account standard world time, transmission of user birth time data from the data logger to the server storage, integration of user data with data of other users, creating links with data of other users, display of user life time information on the interface of the electronic device, recording of user life events time and transmission of user life events data from the data logger to the server storage, display of user life event information on the interface.

The instant application is a National Phase Entry of International Patent Application No. PCT/RU2019/001008 filed on Dec. 24, 2019, and claims priority to Russian Patent Application No. 2018145277, filed on Dec. 29, 2018, the entire specifications of both of which are expressly incorporated herein by reference.

The group of invention refers to a method and equipment for logging, recording data comprising the time and date of birth of a person and storing said data throughout the life of the person linking it to the world time and place of birth.

A clock is used to measure the lifetime of a personal life event (U.S. Pat. No. 6,069,848(A), publ. 30 May 2000), such as marriage, birth, or the beginning of a career from the time of the personal life event. The clock contains a casing and a timer contained within the casing. The timer is configured to measure the elapsed time of the personal life event from the time of occurrence. The clock includes a trigger mechanism that makes the timer start measuring elapsed time from the time of occurrence. The clock contains a display to show the elapsed time. The clock can be implemented digitally and includes a processor programmed to measure elapsed time. Storage memory will also be provided to store data on the personal time-of-life event, including the time the event occurred. A keyboard is used to enter and modify the stored data as well. The memory may include a non-volatile memory component that stores the time of occurrence of the personal time of life event. The non-volatile memory will ensure recovery of elapsed time in the event of a power failure or some other event that result in the loss of elapsed time.

An electronic device and method of using it (U.S. Pat. No. 6,188,311(B1, publ. 13 Feb. 2001) is designed to track events and elapsed time in the life of a child, starting from the time before the birth of the child. Once the current time of day and/or the date and expected date of birth have been programmed, the device counts down the remaining time until birth as months, weeks and days. Once zero is reached, the device can be configured to perform certain celebratory actions, such as flashing the display and playing a melody. The device then automatically switches to timekeeping and displays the instantaneous age of the newborn at any given moment thereafter. As an alternative to the preferred method of use for maternity and birth tracking, the user may program the device for another type of upcoming event, such as an upcoming wedding, retirement and so on.

Disadvantages of the said devices and method can include the temporary nature of data storage, linking the data to a specific device, lack of means to implement linkage of time data with user location data, lack of integration of user data into the main data storage system.

The technical challenge addressed by the alleged inventions is the creation of a method and equipment for implementing the logging, storage and processing of data relating to human birth time, life time and life events, implementing various links between users and time and geographical data.

A technical result of the alleged group of inventions is implementation of possibility of recording and long-term reliable storage of data on time of birth and life events of a person with simultaneous linkage of such data with geographical data and data of other users.

The technical result is achieved due to the method of logging, recording and storing birth time and life events data of a user, which includes recording birth time of a user, recording birth time of a user by entering data into an electronic data logger, linking user birth time to world time and location of user birth, triggering user life time measurement in seconds or minutes or hours or days of planet Earth, taking into account standard world time, transmission of user birth time data from the data logger to the server storage, integration of user data with data of other users, creating links with data of other users, display of user life time information on the interface of the electronic device, recording of user life events time and transmission of user life events data from the data logger to the server storage, display of user life event information on the interface.

An electronic data recording and logging device comprising a means for inputting data necessary to implement a method for logging, recording and storing user's birth time and life event data, a means for processing the data, a means for transferring data from the data logger to the server storage and receiving data from the server storage, a means for displaying the birth time and life event information of a user.

Also alleged within the group of inventions is a machine-readable storage medium with a computer application recorded thereon for carrying out the alleged method when the application is run on a computer or smartphone.

The alleged method is based on logging the time of birth of a user and recording this data using an electronic device. The birth time data is entered into an electronic personal device, which records the data and, due to the availability of data transmission means, transmits the birth time data of the user to server storage for long-term storage. The availability of server storage eliminates the risk of data loss if the electronic data logger fails or is lost.

At the same time as the time of birth of a user is recorded, the place of birth of the user is recorded as well, e.g. using digital publicly available geographical maps. The user birthplace data is also transmitted to the server storage.

According to alleged method life time is recorded in seconds, or minutes, or hours, or days of planet Earth, taking into account correction of universal time standard with possibility to display time data up to hundredths of second.

According to the method it is possible to record life events by entering information into an electronic data logger. Also the recording of life events is possible by linking to a location on electronic public geographical maps. In addition to the time of the life event and the place of the event as data, data in graphical, video or audio format can be entered into the device. Such data may also be transmitted to server storage.

According to the alleged group of inventions, it is possible to transfer user data between electronic data loggers, to process them together and to render the information of several users on a single data logger.

An example of an implementation of the alleged group of inventions may be in the form of an application for smartphones or for posting on a website on the Internet. In case of such an implementation, the user's smartphone or personal computer provides a data logger. The app records the user's time of birth. Through wireless or wired communication channels, the data is stored on server storage, including in the cloud, or on a virtual server. The application will link the entered data to digital public geographic maps and access the audio, video and graphical information stored in the smartphone's memory. The application displays the user's lifetime in seconds. Users of the app can share data with each other, allowing, for example, the display of the lifetimes of all family members or ancestors on the same smartphone, using information about their location and time of birth. If a device is switched, thanks to the implementation of server-based data storage, the user is able to restore all data to the new device.

1. A method for logging, recording and storing user birth time and life event data, comprising logging user birth time, recording user birth time by entering data into an electronic data logger, linking user birth time to world time and user birth location, triggering user life time measurement in seconds, or minutes, or hours, or days of planet Earth taking into account standard world time, transmission of user birth time data from the data logger to the server storage, integration of user data with data of other users, creating links with data of other users, display of user life time information on the interface of the electronic device, recording of user life events time and transmission of user life events data from the data logger to the server storage, display of user life event information on the interface.

2. The method of claim 1, differing in that the user's birth time and life event data is transmitted to the data logger of another user.

3. The method of claim 1, differing in that the user's birth time and life event data is displayed in seconds to the hundredths of a second.

4. The method of claim 1, differing in that the user's birthplace or life event data is recorded using electronic publicly available geographical maps.

5. An electronic data logger for implementation of the method of claim 1, comprising a data input means, a data processing means, a means for transferring data from the data logger to a server storage and receiving data from the server storage, a means for displaying the birth time and life event information of the user.

6. A machine-readable data carrier with a computer application recorded on it for implementing the method of claim 1, where the application is run on a computer or smartphone.
